(19) United States
(12) Patent Application Publication
(10) Pub. No.: US 2024/0089937 A1
(43) Pub. Date: Mar. 14, 2024

(54) EFFICIENT USAGE OF TIME RESOURCE BLOCKS FOR TRANSMITTING REFERENCE SIGNALS

(71) Applicant: Sony Group Corporation, Tokyo (JP)

(72) Inventors: Jose FLORDELIS, Lund (SE); Erik BENGTSSON, Eslöv (SE); Kun ZHAO, Malmö (SE); Fredrik RUSEK, Eslöv (SE); Olof ZANDER, Södra Sandby (SE)

(21) Appl. No.: 18/270,662

(22) PCT Filed: Jan. 13, 2022
(86) PCT No.: PCT/EP2022/050661

§ 371 Date: Jun. 30, 2023

(30) Foreign Application Priority Data
Jan. 15, 2021 (SE) 2150027-7
Jan. 18, 2021 (SE) 2150046-7

(51) Int. Cl. H04W 72/0446; H04L 5/00

(52) U.S. Cl. CPC H04W 72/0446; H04L 5/0048; H04L 5/0094

(57) ABSTRACT

Examples provide a method of operating a first communication node, CN. The method comprises transmitting, on a radio channel by the first CN, a first signal in a first time resource block, in particular a symbol, of a first group of one or more time resource blocks, the first time resource block comprising resource elements, in particular consecutive resource elements in frequency domain, wherein the first number of resource elements comprises resource elements carrying a first instance of a reference signal and resource elements carrying a first instance of a first data message; and transmitting, on the radio channel by first group of one or more time resource blocks, the second time resource block comprising the first number of resource elements, wherein the resource elements of the second time resource block comprise resource elements carrying a second instance of the reference signal and resource elements carrying a second instance of the first data message, wherein the first time resource block is associated with a first transmission direction and the second time resource block is associated with a second transmission direction. Further examples provide a corresponding method of operating a re-configurable relaying device, a first communication node, and a re-configurable relaying device.

### TECHNICAL FIELD

Various examples generally relate to communicating between nodes using re-configurable reflective devices. Various examples specifically relate to repeatedly transmitting reference signals towards the re-configurable reflective devices.

### BACKGROUND

In order to increase a coverage area for wireless communication, it is envisioned to use re-configurable relaying devices (RRD), in particular, re-configurable reflective devices. Re-configurable reflective devices are sometimes also referred to as reflecting large intelligent surface (LIS). See, e.g., Sha Hu, Fredrik Rusek, and Ove Edfors. “Beyond massive MIMO: The potential of data transmission with large intelligent surfaces.” IEEE Transactions on Signal Processing 66.10 (2018): 2746-2758.

An RRD can be implemented by an array of antennas that can reflect incident electromagnetic waves/signals. The array of antennas can be semi-passive. Semi-passive can correspond to a scenario in which the antennas can impose a variable phase shift and typically provide no signal amplification. An input spatial direction from which incident signals on a radio channel are accepted and an output spatial direction into which the incident signals are reflected can be re-configured, by changing a phase relationship between the antennas. Radio channel may refer to a radio channel specified by the 3GPP standard. In particular, the radio channel may refer to a physical radio channel. The radio channel may offer several time/frequency-resources for communication between different communication nodes of a communication system.

An access node (AN) may transmit signals to a wireless communication device (UE) via an RRD. The RRD may receive the incident signals from an input spatial direction and emit the incident signals in an output spatial direction to the UE. The AN may transmit the signals using a beam directed to the RRD. In many scenarios, the relative position and orientation of the AN with respect to the RRD will not change considerably. However, the relative position and orientation of the UE with respect to the RRD may change. Accordingly, the output spatial direction of the RRD may have to be adapted to the relative position and orientation of the UE with respect to the RRD. Heretofore, the AN may send reference signals at certain times to the RRD which emits the reference signals in different output spatial directions. This may also be called a beam sweep. During the beam sweep, the incident signals accepted by the RRD are typically not emitted in an output spatial direction to the UE. In case the UE receives the reference signal, the receive properties determined by the UE may be used to re-configure the RRD. Typically, only a subset of resource elements of a symbol transmitted by the AN are required for carrying the reference signal.

### SUMMARY

Accordingly, there may be a need for a more efficient usage of available resource elements during the transmission of reference signals.

Said need is addressed with the subject matter of the independent claims. The dependent claims describe further advantageous examples.

According to a first aspect, a method is provided of operating a first communication node (CN). The method comprises transmitting, on a radio channel by the first CN, a first signal in a first time resource block, in particular a symbol, of a first group of one or more time resource blocks, the first time resource block comprising a first number of resource elements, in particular consecutive resource elements in frequency domain, wherein the first number of resource elements comprises resource elements carrying a first instance of a reference signal and resource elements carrying a first instance of a first data message for a second CN; and transmitting, on the radio channel by the first CN, a second signal in a second time resource block of the first group of one or more time resource blocks, the second time resource block comprising the first number of resource elements, wherein the resource elements of the second time resource block comprise resource elements carrying a second instance of the reference signal and resource elements carrying a second instance of the first data message for the second CN, wherein the first time resource block is associated with a first transmission direction and the second time resource block is associated with a second transmission direction.

According to a second aspect, a method is provided of operating a re-configurable relaying device (RRD), the RRD being re-configurable to provide spatial filtering, the spatial filtering being associated with an input spatial direction from which incident signals on a radio channel are accepted and with a respective output spatial direction into which the incident signals are emitted by the RRD, the method comprising one of providing a message indicative of the spatial filtering of the RRD at a certain point in time to a first communication node, CN, and obtaining a message for controlling the RRD to have a certain spatial filtering at a certain point in time from the first CN.

According to a third aspect, a first communication node (CN) is provided, wherein the first CN comprises control circuitry causing the first CN to perform transmitting, on a radio channel, a first signal in a first time resource block, in particular a symbol, of a first group of one or more time resource blocks, the first time resource block comprising a first number of resource elements, in particular consecutive resource elements in frequency domain, wherein the first number of resource elements comprises resource elements carrying a first instance of a reference signal and resource elements carrying a first instance of a first data message; and transmitting, on the radio channel, a second signal in a second time resource block of the first group of one or more time resource blocks, the second time resource block comprising the first number of resource elements, wherein the resource elements of the second time resource block comprise resource elements carrying a second instance of the reference signal and resource elements carrying a second instance of the first data message, wherein the first time resource block is associated with a first transmission direction and the second time resource block is associated with a second transmission direction.

According to a fourth aspect, a re-configurable relaying device (RRD) is provided, wherein the RRD is re-configurable to provide spatial filtering, the spatial filtering being associated with an input spatial direction from which incident signals on a radio channel are accepted and with a respective output spatial direction into which the incident signals are emitted by the RRD, and wherein the RRD comprises control circuitry causing the RRD to perform at least one of providing a message indicative of the spatial filtering of the RRD at a certain point in time to a first communication node, CN; obtaining a message for controlling the RRD to have a certain spatial filtering at a certain point in time from the first CN.

### BRIEF DESCRIPTION OF THE DRAWINGS

FIG. 1 schematically illustrates a communication system according to various examples.

FIG. 2 schematically illustrates details of the communication system according to the example of FIG. 1.

FIG. 3 schematically illustrates multiple downlink transmit beams used at a transmitter node of the communication system and further schematically illustrates an RRD towards which one of the multiple transmit beams is directed according to various examples.

FIG. 4 schematically illustrates details with respect to an RRD.

FIG. 5 schematically illustrates a scenario for using an RRD.

FIG. 6 schematically illustrates time/frequency resources for transmitting signals;

FIG. 7 schematically illustrates a communication scenario in a communication system.

FIG. 8 schematically illustrates a transmission of data messages.

FIG. 9 schematically illustrates data payloads of the data messages.

FIG. 10 schematically illustrates a further communication scenario in a communication system.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between nodes. A wireless communication system includes a transmitter node and one or more receiver nodes. In some examples, the wireless communication system can be implemented by a wireless communication network, e.g., a radio-access network (RAN) of a Third Generation Partnership Project (3GPP)-specified cellular network (NW). In such case, the transmitter node can be implemented by a base station (BS) of the RAN, and the one or more receiver nodes can be implemented by terminals (also referred to as user equipment, UE). It would also be possible that the transmitter node is implemented by a UE and the one or more receiver nodes are implemented by a BS and/or further UEs. Hereinafter, for the sake of simplicity, various examples will be described with respect to an example implementation of the transmitter node by a BS and the one or more receiver node by UEs—i.e., to downlink (DL) communication; but the respective techniques can be applied to other scenarios, e.g., uplink (UL) communication and/or sidelink communication.

Communication Via RRDs

According to various examples, the transmitter node can communicate with at least one of the receiver nodes via an RRD.

The RRD may include an antenna array. The RRD may include a meta-material surface. In examples, an RRD may include a reflective antenna array (RAA).

There are many schools-of-thought for how RRDs should be integrated into 3GPP-standardized RANs.

In an exemplary case, the NW operator has deployed the RRDs and is therefore in full control of the RRD operations. The UEs, on the other hand, may not be aware of the presence of any RRD, at least initially, i.e., it is transparent to a UE whether it communicates directly with the BS or via an RRD. The RRD essentially functions as a coverage-extender of the BS. The BS may have established a control link with the RRD.

According to another exemplary case, it might be a private user or some public entity that deploys the RRD. Further, it may be that the UE, in this case, controls RRD operations. The BS, on the other hand, may not be aware of the presence of any RRD and, moreover, may not have control over it/them whatsoever. The UE may gain awareness of the presence of RRD by means of some short-range radio technology, such as Bluetooth, wherein Bluetooth may refer to a standard according to IEEE 802.15, or WiFi, wherein WiFi may refer to a standard according to IEEE 802.11, by virtue of which it may establish the control link with the RRD. It is also possible that the UE gains awareness of the presence of RRD using UWD (Ultra wideband) communication. Using UWB may offer better time resolution due to the wider bandwidth compared to other radio technologies.

In a further exemplary case, neither the UE nor the BS are aware of the presence of the RRD. The RRD may be transparent with respect to a communication between the UE and the BS on a radio channel. The RRD may gain awareness of the UE and/or the BS and re-configure itself based on information obtained from the UE and/or BS.

The three exemplary cases described above are summarized in TAB. 1 below.

TABLE 1
Scenarios for RRD integration into cellular NW

| Scenario | Description | Explanation |
|---|---|---|
| A | BS-RRD | BS controls the RRD and/or can obtain |
| | control link | information from the RRD. A control link is |
| | | established between the BS and the RRD. |
| B | UE-RRD | UE controls the RRD and/or can obtain |
| | control link | information from the RRD. A control link is |
| | | establishedbetween the UE and the RRD. |
| C | transparent | RRD re-configures itself based on information |
| | RRD | obtained from the UE and/or BS. No control |
| | | link is established between the RRD and the |
| | | UE or the BS. |

Hereinafter, techniques will be described which facilitate communication between a transmitter node—e.g., a BS—and one or more receiver nodes—e.g., one or more UEs—using an RRD.

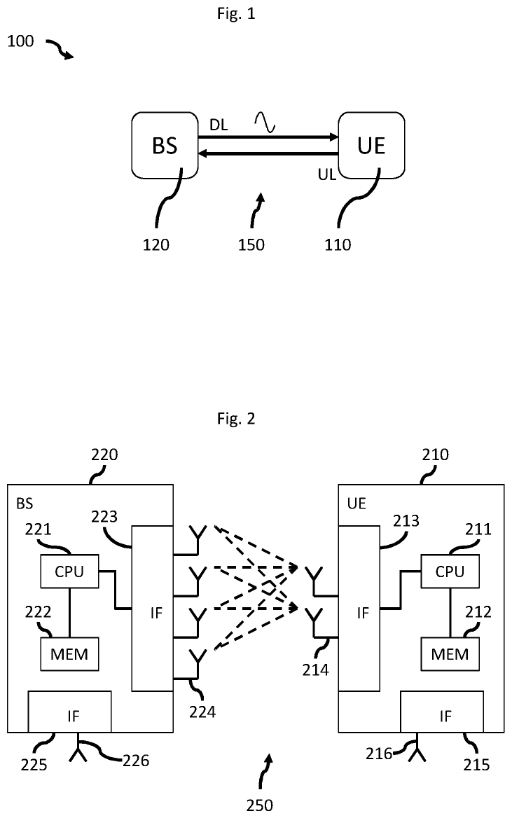

FIG. 1 schematically illustrates a communication system 100. The communication system 100 includes two nodes 110, 120 that are configured to communicate with each other via a radio channel 150. In the example of FIG. 1, the node 120 is implemented by an access node (AN), more specifically a BS, and the node 110 is implemented by a UE. The BS 120 can be part of a cellular NW (not shown in FIG. 1).

As a general rule, the techniques described herein could be used for various types of communication systems, e.g., also for peer-to-peer communication, etc. For the sake of simplicity, however, hereinafter, various techniques will be described in the context of a communication system that is implemented by a BS 120 of a cellular NW and a UE 110.

As illustrated in FIG. 1, there can be DL communication, as well as UL communication. Examples described herein particularly focus on the DL communication, but similar techniques may be applied to UL communication. Input sweep and receive beam sweep may relate to DL communication and output sweep and transmit beam sweep may relate to UL communication.

FIG. 2 illustrates details with respect to the BS 220. The BS 220 includes control circuitry that is implemented by a processor 221 and a non-volatile memory 222. The processor 221 can load program code that is stored in the memory 222. The processor 221 can then execute the program code. Executing the program code causes the processor to perform techniques as described herein.

Moreover, FIG. 2 illustrates details with respect to the UE 210. The UE 210 includes control circuitry that is implemented by a processor 211 and a non-volatile memory 212. The processor 211 can load program code that is stored in the memory 212. The processor can execute the program code. Executing the program code causes the processor to perform techniques as described herein.

Further, FIG. 2 illustrates details with respect to communication between the BS 220 and the UE 210 on the radio channel 250. The BS 220 includes an interface 223 that can access and control multiple antennas 224. Likewise, the UE 210 includes an interface 213 that can access and control multiple antennas 214.

The UE 210 comprises a further interface 215 that can access and control at least one antenna 216 to transmit or receive a signal on an auxiliary radio channel different from the radio channel 250. Likewise, the BS 220 may comprise an additional interface 225 that can access and control at least one antenna 226 to transmit or receive a signal on the or a further auxiliary radio channel different from the radio channel. The radio channel and the auxiliary radio channel may be offset in frequency. The auxiliary radio channel may be at least one of a Bluetooth radio channel, a WiFi channel, or an ultra-wideband radio channel. Methods for determining an angle of arrival may be provided by a communication protocol associated with the auxiliary radio channel. For example, methods for determining an angle of arrival may be provided by a Bluetooth radio channel.

While the scenario of FIG. 2 illustrates the antennas 224, 226 being coupled to the BS 220, as a general rule, it would be possible to employ transmit-receive points (TRPs) that are spaced apart from the BS 220.

The interfaces 213, 223 can each include one or more TX chains and one or more receiver chains. For instance, such RX chains can include low noise amplifiers, analogue to digital converters, mixers, etc. Analogue and/or digital beamforming would be possible.

Thereby, phase-coherent transmitting and/or receiving (communicating) can be implemented across the multiple antennas 214, 224. Thereby, the BS 220 and the UE 210 can selectively transmit on multiple TX beams (beamforming), to thereby direct energy into distinct spatial directions.

By using a TX beam, the direction of the wavefront of signals transmitted by a transmitter of the communication system is controlled. Energy is focused into a respective direction or even multiple directions, by phase-coherent superposition of the individual signals originating from each antenna 214, 224. Thereby, the spatial data stream can be directed. The spatial data streams transmitted on multiple beams can be independent, resulting in spatial multiplexing multi-antenna transmission; or dependent on each other, e.g., redundant, resulting in diversity multi-input multi-output (MIMO) transmission.

As a general rule, alternatively or additionally to such TX beams, it is possible to employ receive (RX) beams.

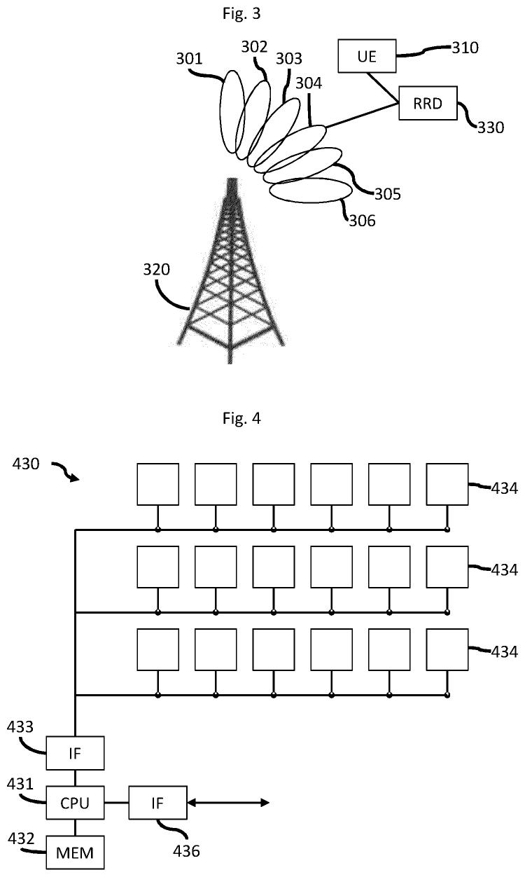

FIG. 3 illustrates DL TX beams 301-306 used by the BS 320. Here, the BS 320 activates the beams 301-306 on different resources (e.g., different time-frequency resources, and/or using orthogonal codes/precoding) such that the UE 310 can monitor for respective signals transmitted on the DL TX beams 301-306.

It is possible that the BS 320 transmits signals to the UE 310 via an RRD 330. In the scenario of FIG. 3, the downlink transmit beam 304 is directed towards the RRD 330. Thus, whenever the BS 320 transmits signals to the UE 310 using the downlink transmit beam 304—e.g., a respective block of a burst transmission—, a spatial filter is provided by the RRD 330. The spatial filter is associated with a respective spatial direction into which the incident signals are then selectively reflected by the RRD 330. Details with respect to the RRD 330 are illustrated in connection with FIG. 4.

FIG. 4 illustrates aspects in connection with the RRD 430. The RRD 430 includes a phased array of antennas 434 that impose a configurable phase shift when reflecting incident signals. This defines respective spatial filters that may be associated with spatial directions into which the incident signals are reflected. The antennas 434 can be passive or semi-passive elements. The RRD 430 thus provides coverage extension by reflection of radio-frequency (RF) signals. A translation to the baseband may not be required. This is different, to, e.g., decode-and-forward repeater or relay functionality. The antennas 434 may induce an amplitude shift by attenuation. In some examples, the antennas 434 may provide forward amplification without translation of signals transmitted on the radio channel to the base band. The antennas 434 may amplify and forward the signals.

The RRD 430 includes an antenna interface 433 which controls an array of antennas 434; a processor 431 can activate respective spatial filters one after another. The RRD 430 further includes an interface 436 for receiving and/or transmitting signals on an auxiliary radio channel 460. There is a memory 432 and the processor 431 can load program code from the non-volatile memory and execute the program code. Executing the program code causes the processor to perform techniques as described herein.

FIG. 4 is only one example implementation of the RRD. Other implementations are conceivable. For example, a meta-material surface not including distinct antenna elements may be used. The meta-material can have a configurable refraction index. To provide a re-configurable refraction index, the meta-material may be made of repetitive tunable structures that have extensions smaller than the wavelength of the incident RF signals.

Transmitting Data Messages in Time Resource Blocks Used for Reference Signals

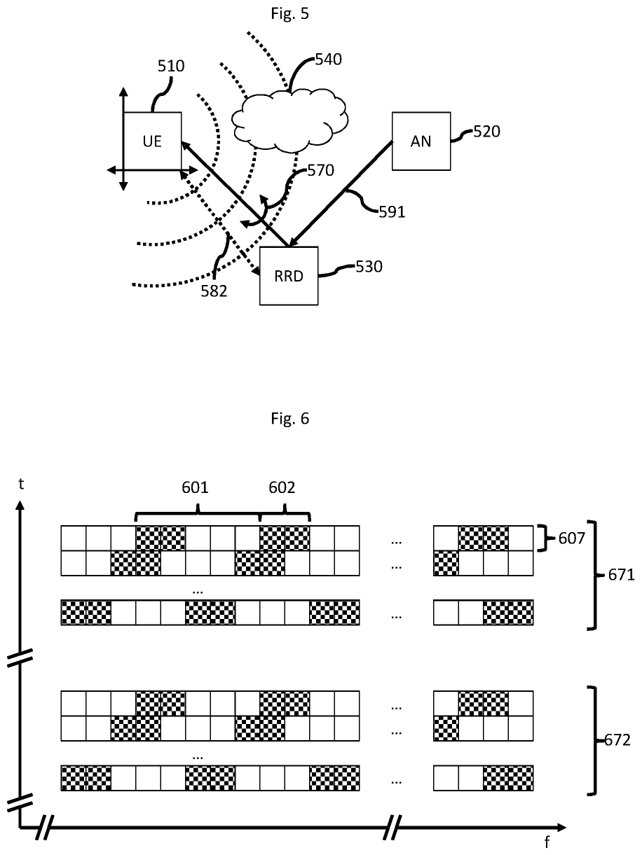

FIG. 5 illustrates an exemplary scenario C as described hereinbefore with reference to TAB. 1. A UE 510 is to communicate with an AN 520 over a radio channel 591. The radio channel may be a 5G NR channel, in particular, a 5G NR channel in Frequency Range 2 or beyond. An obstacle 540 between the UE 510 and the AN 520 may impede the communication between the UE 510 and the AN 520 on the radio channel.

An RRD 530 may be employed to provide a supplemental physical transmission path for the communication over the radio channel. The UE 510 and the AN 520 may be unaware of the presence of the RRD 530. In some examples, the position and orientation of the RRD 530 with respect to the AN 520 may be fixed and known to the RRD 530. As described hereinbefore, the RRD 530 may be semi-passive and free of circuitry to translate signals on a radio channel to the baseband.

The RRD 530 may provide multiple spatial filters, wherein each one of the multiple spatial filters is associated with a respective input spatial direction from which incident signals on a radio channel are accepted and with a respective output spatial direction into which the incident signals are reflected by the RRD.

The RRD 530 may perform an output sweep 570 comprising changing the output spatial direction while using the given input spatial direction. In particular, the output sweep 570 may be performed over signals transmitted by the AN 520. For example, the RRD 530 can toggle through different output spatial directions by changing the phase relationships between the antenna elements.

The AN may send reference signals at certain times to the RRD which emits the reference signals in different output spatial directions. During the beam sweep, the incident signals accepted by the RRD are typically not emitted in an output spatial direction to the UE. In case the UE receives the reference signal, the receive properties determined by the UE may be used to re-configure the RRD. Typically, only a subset of resource elements available for transmission of signals by the AN is required for carrying the reference signal. The instances of the reference signal transmitted in the first and in the second time resource blocks may comprise different sequences and may further be assigned to different resource elements within the time resource blocks. However, in the following, the sequences may be assumed to be identical. Moreover, the resource elements used in the first time resource block for carrying the first instance of the reference signal and the resource elements used in the second time resource block for carrying the second instance of the reference signal may be located at identical locations.

FIG. 6 illustrates time/frequency resources for transmitting signals in the beams 570 illustrated in FIG. 5. In particular, FIG. 6 shows a first time resource block 671 and a second time resource block 672. Each time resource block 671, 672 comprises a number of resource elements indicated with squares in FIG. 6.

The first time resource block 671 may comprise one or more symbols 607. Likewise the second time resource block 672 may comprise one or more symbols. Typically, the first time resource block 671 and the second time resource block 672 will consist of the same number of symbols and/or the same number of resource elements. The symbols may correspond to OFDM (orthogonal frequency-division multiplexing) symbols.

As explained above, only a subset of resource elements may be required for transmitting reference signals. The resource elements carrying reference signals are shown with a checkboard pattern in FIG. 6. The distance 601 may be considered a repetition period of the resource elements in the frequency domain and the distance 602 may correspond to a burst length in the frequency domain.

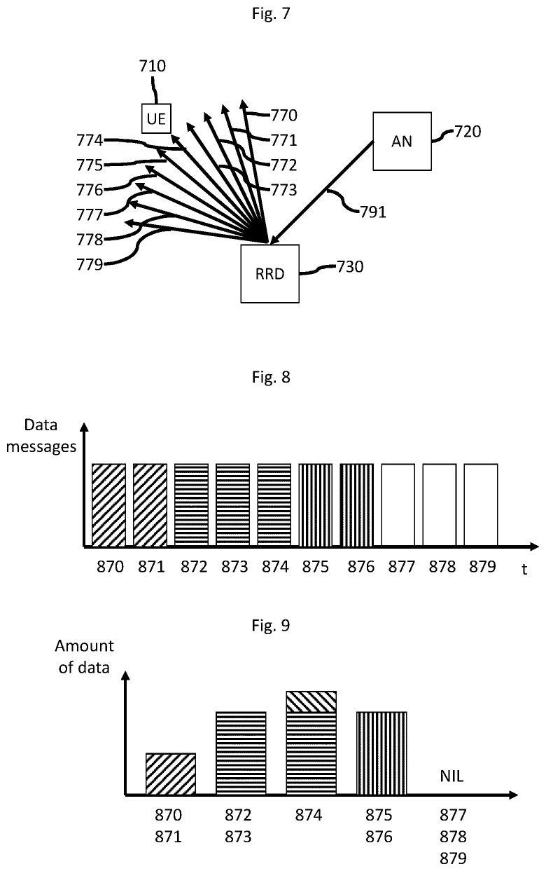

As shown in FIG. 7, an AN 720 may transmit signals in a direction 791 to the RRD 730 at different points in time. For example, a first signal may be transmitted by the AN 720 to the RRD 730 at a first point in time and a second signal may be transmitted by the AN 720 to the RRD 730 at a second point in time. The first point in time may be associated with a first spatial filtering of the RRD 730 and the second point in time may be associated with a second spatial filtering of the RRD 730. For example, the first spatial filtering may be associated with an input spatial direction from which the incident first signal on the radio channel is accepted corresponding to the spatial direction 791 and an output spatial direction into which the incident first signal will corresponding to the spatial direction 772. The second spatial filtering may be associated with the same input spatial direction 791. At the second point in time, the second signal will be accepted by the RRD 730. The second spatial filtering may be associated with a different output spatial direction into which the second signal will be emitted. For example, the RRD 730 may emit the second signal in the direction 773. The first signal and the second signal may be transmitted by the AN 720 while the RRD 730 performs a beam sweep.

A first signal may be transmitted in a first time resource block associated with a first transmission direction 772 and the second signal may be transmitted in a second time resource block associated with a second transmission direction 773. In particular, the first signal may be transmitted in a first time resource block of a first group of one or more time resource blocks, wherein the first time resource block comprises a first number of resource elements. The first number of resource elements may comprise a first subset of resource elements carrying a first instance of a reference signal and a second subset of resource elements carrying a first instance of a first data massage for the UE 710. In particular, the first data massage may be configured for being decoded by the UE 710. The AN 720 may transmit the second signal in a second time resource block of the first group of one or more resource blocks, wherein the second time resource block comprises the first number of resource blocks. The resource elements of the second time resource block comprise the first subset of resource elements carrying a second instance of the reference signal and a third subset of resource elements carrying a second instance of the first data massage for the same UE 710. In particular, the first instance and the second instance of the first data massage are configured for being decoded by one and the same UE 710. The first and second time resource blocks may comprise the same number of resource elements. For example, the first and second time resource blocks may each comprise 330 resource elements.

Providing instances of the same data message in signals, which are associated with different transmission directions may allow for the transmission of data even if it cannot be assured that UE 710 receives each signal. Thus, signals transmitted by the AN 720 during a beam sweep of the RRD 730 may also carry data and the available time/frequency resources may be used more efficiently.

The AN 720 may transmit a third signal in a third time resource block, wherein the third time resource block comprises the first number of resource elements. The third time resource block may be associated with a further transmission direction. For example, the third time resource block may be associated with transmission direction 774. The resource elements of the third time resource block may comprise a fourth subset of resource elements carrying a further instance of the first data message. The third time resource block may be free of resource elements carrying an instance of the first reference signal. For example, in the scenario of FIG. 7, the transmission direction 774 may correspond to an already established connection between the UE 710 and the AN 720. For example, the transmission direction 774 may correspond to a serving beam. Thus, transmitting a reference signal may not be required every time a beam sweep is performed. Instead, the resource elements carrying the reference signal in the other time resource blocks may be used for transmitting additional data.

In some scenarios, the AN 720 may transmit a fourth signal in a fourth time resource block of a second group of one or more time resource blocks, wherein the fourth time resource block comprises the first number of resource elements. The resource elements of the fourth time resource block may comprise the first subset of resource elements, which carry a third instance of the reference signal. Further, the resource elements may comprise a sixth subset of resource elements carrying a second data message. The second data message may be different from the first data message. In some examples, the second data message may be configured for being decoded by a further UE different from the UE 710. In other examples, the second data message may be configured for being decoded by the UE 710. For example, if the UE 710 is at a first location it may receive signals comprising the first data message and if the UE 710 is at a second location, it may receive signals comprising the second data message.

FIG. 8 illustrates data messages 870 to 879 carried by resource elements of time resource blocks for different transmission directions 770 to 779, respectively. As shown, time resource blocks of a first group of time resource blocks associated with the transmission directions 770, 771 may carry a first instance 870 of a first data message and a second instance 871 of the same first data message as indicated by the corresponding hatching. Further, time resource blocks of a second group of time resource blocks associated with the transmission directions 772, 773, 774 may carry a same second data message 872, 873, 874, different from the first data message. Time resource blocks of a third group of time resource blocks associated with the transmission directions 775, 776 may carry a same third data message 875, 876, different from the first and/or second data message. Time resource blocks of a fourth group of time resource blocks associated with the transmission directions 777, 778, 779 may carry the same (empty) fourth data message 877, 878, 879. An empty data message may correspond to not transmitting a data message in the respective time resource block.

FIG. 9 illustrates the amount of data carried by the data message in the respective groups of time resource blocks. The transmission directions 770, 771 are quite distant from the serving transmission direction 770 or serving beam. Hence, it may be assumed that the UE 710 may receive signals transmitted in said direction only with difficulties. Thus, the amount of data transmitted in the data messages 870, 871 may be low. For example, the data transmitted in the data message may be encoded with an algorithm allowing for an error detection by the UE 710. The transmission directions 772, 773, 774 (or transmission beams) may be closer to or identical to the serving beam. Accordingly, signals transmitted in these directions 772, 773, 774 may be assumed to be received more reliably. Hence, as shown in FIG. 9, the data transmitted in data messages 872, 873, 874 in time resource blocks belonging to this resource block group may be increased. Furthermore, additional data shown with a different crosshatch pattern may be transmitted in the time resource block associated with the transmission direction 710 using resource elements which are used for transmitting the positioning signal in the other time resource blocks associated with the other transmission directions. The data messages 875, 876 associated with the time resource blocks for the transmission directions 775, 776 may have the same amount of data than the data messages 875, 876. However, the data itself may be different. Furthermore, as indicated above, no data may be transmitted using data messages 877, 878, 879. In particular, encoding of data at the AN 720 may be omitted, in case no sufficient reception quality at the UE 710 for data transmission is expected. This may reduce calculation effort and power consumption at the AN 720.

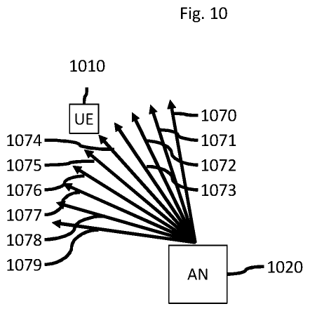

FIG. 10 shows a further example of a communication system comprising a UE 1010 and an AN 1020. In contrast to the scenario described with respect to FIG. 7, the AN 1020 transmits the signals toward the UE directly in different output spatial directions 1070 to 1079, i.e., not via an RRD. The different signals may be transmitted in the different output spatial directions 1070 to 1079 at the same time. However, the different signals may also be transmitted in the different output spatial directions 1070 to 1079 at different points in time. This may be considered as a beam sweep performed by the AN 1020.

In examples, the first signal may be transmitted in the transmission direction 1070 and the second signal may be transmitted in the transmission direction 1071. Like in the scenario of FIG. 7, the first signal may be transmitted in a first time resource block associated with a first transmission direction and the second signal may be transmitted in a second time resource block associated with a second transmission direction. In particular, the first signal may be transmitted in a first time resource block of a first group of one or more time resource blocks, wherein the first time resource block comprises a first number of resource elements. The first number of resource elements may comprise resource elements, in particular a first subset of resource elements, carrying a first instance of a reference signal and resource elements, in particular a second subset of resource elements, carrying a first instance of a data massage. The AN 1020 may transmit the second signal in a second time resource block of the first group of one or more resource blocks, wherein the second time resource block comprises the first number of resource blocks. The resource elements of the second time resource block comprise resource elements, in particular the first subset of resource elements, carrying a second instance of the reference signal and resource elements, in particular a third subset of resource elements, carrying a second instance of the first data massage. The first time resource block is associated with a first transmission direction and the second time resource block is associated with a second transmission direction.

Providing instances of the same data message in signals, which are associated with different transmission directions may allow for the transmission of data even if it cannot be assured that UE 1010 receives each signal. Thus, signals used during a beam sweep may also carry data and the available time/frequency resources may be used more efficiently.

As is clear from the example set out with reference to FIG. 10, while the present disclosure has particular advantages when used in a system which relies on an RRD, some advantages may still be achieved in systems which do not rely on an RRD. As such, the present disclosure is, in general, applicable to both scenarios.

Although the disclosure has been shown and described with respect to certain preferred examples, equivalents and modifications will occur to others skilled in the art upon the reading and understanding of the specification. The present disclosure includes all such equivalents and modifications and is limited only by the scope of the appended claims.

For illustration, while various scenarios have been illustrated in the context of a DL transmission, in which a first communication node is implemented as an AN 720 and a second communication node is implemented as a UE 710, and wherein the transmission implies using the RRD 730, similar techniques can be applied for, e.g., transmissions from a UE to an AN or between two mobile devices, e.g., to UEs on a sidelink or generally using device-to-device (D2D) communication. In particular for scenarios in which the transmitter node moves relatively with respect to the RRD, the spatial direction into which incident signals are selectively reflected by the RRD depends on the respective spatial filter provided by the RRD, but also depends on the spatial direction with which the incident signals arrive at the RRD (wherein this direction depends on the relative movement of the transmitter node with respect to the RRD).

For further illustration, above, various scenarios have been described in which the spatial filter provided by the RRD is associated with a respective spatial direction into which the incident signals are reflected. It is, as a general rule, possible, that the spatial filter is designed to provide a reflection into a single spatial direction or multiple spatial directions.

For further illustration, well above various scenarios have been described with an implementation of the RRD using an antenna array, similar techniques may be readily applied to other kinds and types of surfaces having a re-configurable refractive index.

As explained, RRDs or LIS (large intelligent surface) reflectors are foreseen to be an essential part of mm-wave communication systems to combat large propagation loss and blocking.

Summarizing, at least the following examples have been described above:

EXAMPLE 1. A method of operating a first communication node, CN, the method comprising:
transmitting, on a radio channel by the first CN, a first signal in a first time resource block of a first group of one or more time resource blocks, the first time resource block comprising a first number of resource elements,

wherein the first number of resource elements comprises resource elements carrying a first instance of a reference signal and resource elements carrying a first instance of a first data message for a second CN;
transmitting, on the radio channel by the first CN, a second signal in a second time resource block of the first group of one or more time resource blocks, the second time resource block comprising the first number of resource elements,

wherein the resource elements of the second time resource block comprise resource elements carrying a second instance of the reference signal and resource elements carrying a second instance of the first data message for the second CN,

wherein the first time resource block is associated with a first transmission direction and the second time resource block is associated with a second transmission direction.

EXAMPLE 2. A method of operating a first communication node, CN, the method comprising:
transmitting, on a radio channel by the first CN, a first signal in a first time resource block, in particular a symbol, of a first group of one or more time resource blocks, the first time resource block comprising a first number of resource elements, in particular consecutive resource elements in frequency domain,

wherein the first number of resource elements comprises a first subset of resource elements carrying a first instance of a reference signal and a second subset of resource elements carrying a first instance of a first data message for a second CN;
transmitting, on the radio channel by the first CN, a second signal in a second time resource block of the first group of one or more time resource blocks, the second time resource block comprising the first number of resource elements, wherein the resource elements of the second time resource block comprise the first subset of resource elements carrying a second instance of the reference signal and a third subset of resource elements carrying a second instance of the first data message for the second CN,

wherein the first time resource block is associated with a first transmission direction and the second time resource block is associated with a second transmission direction.

EXAMPLE 3. The method of operating the first CN of EXAMPLE 1 or 2,

wherein the first signal is transmitted, by the first CN, in the first transmission direction,

wherein the second signal is transmitted, by the first CN, in the second transmission direction.

EXAMPLE 4. The method of operating the first CN of EXAMPLE 1 or 2,

wherein the first CN is configured for communicating via a re-configurable relaying device, RRD, the RRD being re-configurable to provide spatial filtering, the spatial filtering being associated with an input spatial direction from which incident signals on the radio channel are accepted and with a respective output spatial direction into which the incident signals are emitted by the RRD,

wherein the first signal is transmitted, by the first CN, to an RRD, at a first point in time, the first point in time being associated with a first spatial filtering of the RRD; wherein the second signal is transmitted, by the CN, to the RRD, at a second point in time, the second point in time being associated with a second spatial filtering of the RRD,

wherein the first spatial filtering is different from the second spatial filtering.

EXAMPLE 5. The method of operating the first CN of any one of EXAMPLEs 1 to 4,

wherein a same resource element of the first time resource block and the second time resource block carry a same part of the first reference signal.

EXAMPLE 6. The method of operating the first CN of any one of EXAMPLEs 1 to 5,

wherein a same resource element of the first time resource block and the second time resource block carry a same part of the first data message.

EXAMPLE 7. The method of operating the first CN of any one of EXAMPLEs 1 to 4,

wherein a same resource element of the first time resource block and the second time resource block carry a different part of the first data message.

EXAMPLE 8. The method of operating the first CN of any one of EXAMPLEs 1 to 7,

wherein the first and second time resource blocks each comprise OFDM symbols, in particular wherein each of the first and second time resource blocks comprise one OFDM symbol or each of the first and second time resource blocks comprise four, more particularly four consecutive, OFDM symbols.

EXAMPLE 9. The method of operating the first CN of any one of claims 1 to 8,

wherein the method comprises:
transmitting, on the radio channel by the first CN, a third signal in a third time resource block, the third time resource block comprising the first number of resource elements,

wherein the resource elements of the third time resource block comprise resource elements carrying a third instance of the first data message, and

wherein the third time resource block is free of resource elements carrying an instance of the first reference signal.

EXAMPLE 10. The method of operating the first CN of any one of EXAMPLEs 1 to 9, wherein the method comprises:
transmitting, on the radio channel by the first CN, a third signal in a third time resource block, the third time resource block comprising the first number of resource elements,

wherein the resource elements of the third time resource block comprises a fourth subset of resource elements carrying a third instance of the first data message, and

wherein the third time resource block is free of resource elements carrying an instance of the first reference signal.

EXAMPLE 11. The method of operating the first CN of any one of claims 1 to 10, wherein the method comprises:
transmitting, on the radio channel by the first CN, a fourth signal in a fourth time resource block of a second group of one or more time resource blocks, the fourth time resource block comprising the first number of resource elements,

wherein the resource elements of the fourth time resource block comprise resource elements carrying a third instance of the reference signal and resource elements carrying a second data message,

wherein the second data message is different from the first data message.

EXAMPLE 12. The method of operating the first CN of any one of EXAMPLEs 2 to 11, wherein the method comprises:
transmitting, on the radio channel by the first CN, a fourth signal in a fourth time resource block of a second group of one or more time resource blocks, the fourth time resource block comprising the first number of resource elements,

wherein the resource elements of the fourth time resource block comprise the first subset of resource elements carrying a third instance of the reference signal and a sixth subset of resource elements carrying a second data message, in particular a second data message for the second CN or a third CN,

wherein the second data message is different from the first data message.

EXAMPLE 13. The method of operating the first CN of any one of EXAMPLEs 1 to 12,

wherein an amount of data carried by the second data message is different from an amount of data carried by the first data message.

EXAMPLE 14. The method of operating the first CN of EXAMPLE 13,

wherein the amount of data carried by the second data message is zero.

EXAMPLE 15. The method of operating the first CN of any one of EXAMPLEs 4 to 14, wherein the method further comprises:
obtaining a message indicative of a spatial filtering of the RRD at a certain point in time.

EXAMPLE 16. The method of operating the first CN of EXAMPLE 15, wherein the method further comprises:
communicating, on the radio channel via the RRD, with a second CN, and
obtaining the message indicative of the spatial filtering of the RRD at a certain point in time from the second CN.

EXAMPLE 17. The method of operating the first CN of EXAMPLE 15,

wherein the method further comprises:
obtaining the message indicative of the spatial filtering of the RRD at a certain point in time directly from the RRD.

EXAMPLE 18. The method of operating the first CN of any one of EXAMPLEs 4 to 14, wherein the method further comprises:
providing a message for controlling the RRD to have a certain spatial filtering at a certain point in time.

EXAMPLE 19. The method of operating the first CN of EXAMPLE 18,

wherein the method further comprises:
providing the message for controlling the RRD to have a certain spatial filtering at a certain point in time directly to the RRD.

EXAMPLE 20. The method of operating the first CN of EXAMPLE 18, wherein the method further comprises:
communicating, on the radio channel via the RRD, with a second CN, and
providing to the message for controlling the RRD to have a certain spatial filtering at a certain point in time to the second CN.

EXAMPLE 21. The method of operating the first CN of any one of EXAMPLEs 1 to 20,

wherein at least one of the first, second, third or fourth time resource blocks carries information on an amount of data carried by the first data message and/or the resource elements carrying the first data message.

EXAMPLE 22. A method of operating a re-configurable relaying device, RRD, the RRD being re-configurable to provide spatial filtering, the spatial filtering being associated with an input spatial direction from which incident signals on a radio channel are accepted and with a respective output spatial direction into which the incident signals are emitted by the RRD, the method comprising one of
providing a message indicative of the spatial filtering of the RRD at a certain point in time to a first communication node, CN,
obtaining a message for controlling the RRD to have a certain spatial filtering at a certain point in time from the first CN.

EXAMPLE 23. A first communication node, CN,

wherein the first CN comprises control circuitry causing the first CN to perform:
transmitting, on a radio channel, a first signal in a first time resource block of a first group of one or more time resource blocks, the first time resource block comprising a first number of resource elements,

wherein the first number of resource elements comprises resource elements carrying a first instance of a reference signal and resource elements carrying a first instance of a first data message for a second CN;
transmitting, on the radio channel, a second signal in a second time resource block of the first group of one or more time resource blocks, the second time resource block comprising the first number of resource elements,

wherein the resource elements of the second time resource block comprise resource elements carrying a second instance of the reference signal and resource elements carrying a second instance of the first data message for the second CN,

wherein the first time resource block is associated with a first transmission direction and the second time resource block is associated with a second transmission direction.

EXAMPLE 24. A first communication node, CN,

wherein the first CN comprises control circuitry causing the first CN to perform:
transmitting, on a radio channel, a first signal in a first time resource block, in particular a symbol, of a first group of one or more time resource blocks, the first time resource block comprising a first number of resource elements, in particular consecutive resource elements in frequency domain,

wherein the first number of resource elements comprises a first subset of resource elements carrying a first instance of a reference signal and a second subset of resource elements carrying a first instance of a first data message for a second CN;
transmitting, on the radio channel, a second signal in a second time resource block of the first group of one or more time resource blocks, the second time resource block comprising the first number of resource elements,

wherein the resource elements of the second time resource block comprise the first subset of resource elements carrying a second instance of the reference signal and a third subset of resource elements carrying a second instance of the first data message for the second CN,

wherein the first time resource block is associated with a first transmission direction and the second time resource block is associated with a second transmission direction.

EXAMPLE 25. A first communication node, CN, in particular the first CN of EXAMPLE 23 or 24, wherein a or the control circuitry of the CN is configured for performing the method of any one of EXAMPLEs 1 to 22.

EXAMPLE 26. A re-configurable relaying device, RRD,

wherein the RRD is re-configurable to provide spatial filtering, the spatial filtering being associated with an input spatial direction from which incident signals on a radio channel are accepted and with a respective output spatial direction into which the incident signals are emitted by the RRD, and

wherein the RRD comprises control circuitry causing the RRD to perform at least one of
providing a message indicative of the spatial filtering of the RRD at a certain point in time to a first communication node, CN,
obtaining a message for controlling the RRD to have a certain spatial filtering at a certain point in time from the first CN.

1. A method of operating a first communication node (CN) the method comprising:
transmitting, on a radio channel by the first CN, a first signal in a first time resource block of a first group of one or more time resource blocks, the first time resource block comprising a first number of resource elements, wherein the first number of resource elements comprises resource elements carrying a first instance of a reference signal and resource elements carrying a first instance of a first data message for a second CN;
transmitting, on the radio channel by the first CN, a second signal in a second time resource block of the first group of one or more time resource blocks, the second time resource block comprising the first number of resource elements, wherein the resource elements of the second time resource block comprise resource elements carrying a second instance of the reference signal and resource elements carrying a second instance of the first data message for the second CN, wherein the first time resource block is associated with a first transmission direction and the second time resource block is associated with a second transmission direction.

2. The method of operating the first CN of claim 1,
wherein the resource elements of the first time resource block carrying the first instance of the reference signal form a first subset and the resource elements of the first time resource block carrying the first instance of the data message form a second subset, and
wherein the resource elements of the second time resource block carrying the second instance of the reference signal belong to the first subset and the resource elements of the second time resource block carrying the second instance of the data message form a third subset.

3. The method of operating the first CN of claim 1, wherein the first signal is transmitted, by the first CN, in the first transmission direction, wherein the second signal is transmitted, by the first CN, in the second transmission direction.

4. The method of operating the first CN of claim 1,
wherein the first CN is configured for communicating via a re-configurable relaying device (RRD) the RRD being re-configurable to provide spatial filtering, the spatial filtering being associated with an input spatial direction from which incident signals on the radio channel are accepted and with a respective output spatial direction into which the incident signals are emitted by the RRD,
wherein the first signal is transmitted, by the first CN, to an RRD, at a first point in time, the first point in time being associated with a first spatial filtering of the RRD; wherein the second signal is transmitted, by the CN, to the RRD, at a second point in time, the second point in time being associated with a second spatial filtering of the RRD,
wherein the first spatial filtering is different from the second spatial filtering.

5. The method of operating the first CN of claim 1, wherein a same resource element of the first time resource block and the second time resource block carry a same part of the first reference signal.

6. The method of operating the first CN of claim 1, wherein a same resource element of the first time resource block and the second time resource block carry a same part of the first data message.

7. The method of operating the first CN of claim 1, wherein a same resource element of the first time resource block and the second time resource block carry a different part of the first data message.

8. The method of operating the first CN of claim 1, wherein the first and second time resource blocks each comprise OFDM symbols.

9. The method of operating the first CN of claim 1, wherein the method comprises:
transmitting, on the radio channel by the first CN, a third signal in a third time resource block, the third time resource block comprising the first number of resource elements,
wherein the resource elements of the third time resource block comprise resource elements carrying a third instance of the first data message, and
wherein the third time resource block is free of resource elements carrying an instance of the first reference signal.

10. The method of operating the first CN of claim 9, wherein the resource elements carrying the third instance of the first data message form a fourth subset.

11. The method of operating the first CN of claim 1, wherein the method comprises:
transmitting, on the radio channel by the first CN, a fourth signal in a fourth time resource block of a second group of one or more time resource blocks, the fourth time resource block comprising the first number of resource elements, wherein the resource elements of the fourth time resource block comprise resource elements carrying a third instance of the reference signal and resource elements carrying a second data message,
wherein the second data message is different from the first data message.

12. The method of operating the first CN of claim 2,
wherein the resource elements carrying the third instance of the reference signal belong to the first subset, and
wherein the resource elements carrying the second data message form a sixth subset.

13. The method of operating the first CN of claim 1, wherein an amount of data carried by the second data message is different from an amount of data carried by the first data message.

14. The method of operating the first CN of claim 13, wherein the amount of data carried by the second data message is zero.

15. The method of operating the first CN of claim 4, wherein the method further comprises:
obtaining a message indicative of a spatial filtering of the RRD at a certain point in time.

16. The method of operating the first CN of claim 15, wherein the method further comprises:
communicating, on the radio channel via the RRD, with a second CN, and
obtaining the message indicative of the spatial filtering of the RRD at a certain point in time from the second CN.

17. The method of operating the first CN of claim 16, wherein the method further comprises:
obtaining the message indicative of the spatial filtering of the RRD at a certain point in time directly from the RRD.

18. The method of operating the first CN of claim 4, wherein the method further comprises:
providing a message for controlling the RRD to have a certain spatial filtering at a certain point in time.

19. The method of operating the first CN of claim 18, wherein the method further comprises:
providing the message for controlling the RRD to have a certain spatial filtering at a certain point in time directly to the RRD.

20. The method of operating the first CN of claim 18, wherein the method further comprises:
communicating, on the radio channel via the RRD, with a second CN, and
providing to the message for controlling the RRD to have a certain spatial filtering at a certain point in time to the second CN.

21-25. (canceled)
